(19) United States
(12) Patent Application Publication
(10) Pub. No.: US 2010/0037273 A1
(43) Pub. Date: Feb. 11, 2010

(54) INTERACTIVE VIDEO PRESENTATION

(76) Inventors: Brian Dressel, Chicago, IL (US); Peter Nyboer, San Jose, CA (US)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/538,075

(22) Filed: Aug. 7, 2009

Related U.S. Application Data
(60) Provisional application No. 61/086,901, filed on Aug. 7, 2008.

(51) Int. Cl. H04N 7/173

(52) U.S. Cl. 725/105

(57) ABSTRACT

A system in accordance with the invention includes an interactive video system that creates immersive multimedia experiences through responsive physical interaction and audience participation. The system transform floors, walls, screens, staging and other surfaces and video output devices into an interactive experience. Motion tracking and projection systems enable the combination of a background message to be manipulated in response to audience participation, including human body movements. Included within the system is a software application with a setup and programming user interface, used in conjunction with external hardware to which it is connected. External hardware includes, in one basic embodiment, one or more video projectors, one or more video cameras, and one or more computers. The computer receives input from the video cameras, and modifies the projected video based upon that input. A single system unit can be networked to other system units on a LAN, WAN, or global network.

### CROSS REFERENCE TO RELATED APPLICATIONS

This application claims the benefit of priority to U.S. Provisional Patent Application No. 61/086,901, filed Aug. 7, 2008, the contents of which are hereby incorporated by reference in their entirety.

### FIELD OF THE INVENTION

The present invention relates to a system for creatively modifying a visual output display, including a video display, generating an immersive experience based on movements and interaction with a live animal, typically humans, using electronic and mechanical tracking devices.

### BACKGROUND OF THE INVENTION

Computer software application for creating interesting artistic visual images are known, wherein a user controls a mouse or stylus to effectively “paint” using the computer. A variety of visual effects may be produced, but all require practice and skill to produce. Further, the interaction is limited to the dexterity of the users hand, and output of a typical computer user output display.

In addition to computer based painting and graphics programs, which are well known, computer applications further exist which include a pair of eyes, locatable on a video output screen, which move together in the manner of human eyes, and which appear to follow the location of a mouse cursor as it is moved upon the screen.

Video projection applications are known which sense the presence of a viewer and activate video content based upon that presence. These systems do not, however, enable the viewer to creatively modify the video content observed.

While these applications are amusing, they require practice and skill to enjoy, or are limited in their response, or require the use of an input device such as a mouse. A need therefore exists for a creative, artistic, and imaginative tool which does not require skill to use, and which may be caused to produce a wider variety of interesting artistic or visual results in response to a users input, and which do not require the user to manipulate a mechanical user input device.

### SUMMARY OF THE INVENTION

An interactive system in accordance with the invention creates immersive multimedia experiences through responsive physical interaction and audience participation. The interactive system enables a transformation of surfaces, including floors, walls, screens, and stages, into a captivating interactive experience.

As explained further, below, the system of the invention enables entertaining and engaging audiences by turning them into active participants. The system includes one or more tracking devices operative to detect movement of a participant, a computer system including software, and at least one visible display output device.

The system of the invention provides for motion video or other visually projected output that changes and evolves, in cooperation with the viewer or participant, whereby the participant may continuously interact with the projected output. Existing media or display content may provided for the projected output, advantageously as a background to be modified by movement one or more players, participants or users.

External hardware includes, in one embodiment, one or more video projectors, one or more video cameras, and one or more computers. The computer receives an input signal from video cameras or other tracking devices, or multiple tracking devices working together, and modifies the displayed or visible output based upon that input. The computer may also be used to control other devices such as room or effects lighting, LED or LCD video screens, motors, solenoids, servos, audio devices and synthesizers, or any combination of these and other such output devices, controllable by sending an output signal, using any or all of wireless protocols, serial control, Open Sound Control (OSC), Musical Instrument Digital Interface (MIDI), TUIO protocol, or computer networking protocol devices or commands.

A single system computer can be networked to other system computers around the world. In accordance with the invention, a coordinating application of the invention, which may be a Web based application, is used to push or pull new content and playlists (programmed content) to one or more computers using the internet. Multiport devices as known in the art may be connected to computer to enable connections to a plurality of similar devices. According to the invention, output to multiple devices of a similar type are coordinated to present a single seamless or substantially seamless output presentation using software of the invention.

A tracking device, for example video camera, is positioned to detect movement of a user in a stage area. Wave emitting devices, for example IR projectors, including infrared lasers or infrared LED clusters, are aimed in cooperation with the camera, enhancing contrast by reflecting infrared light to the stage area or visible display surface and back to the camera. The use of this supplemental light, and particularly light within the IR wavelength, is particularly advantageous in applications where visible light is insufficient for producing good contrast by tracking device 260. Additionally, by configuring or using a tracking device 260 to only, or predominantly detect non-visible wave energy, such as IR, the tracking device is not adversely impacted by visible light reflected from visible output.

The output signals generated from the various tracking devices, such as the video or motion sensors, are read or digitized in real-time by the system software of the invention. In accordance with the invention, digitizing methods include point tracking, or the application of a difference function based on input from successive video frames. Data extracted from these messages is used to apply various effects and graphics, or control information of the output signal to the connected output device. An LCD monitor, video projector or LED video wall, for example, is advantageously used as a display output. Multiple video projectors may be tiled together contiguously, in order to form one large screen. Alternatively, other types of display output devices may be tiled together.

Additionally, the shape of the projected image may have a mask applied within software, whereby portions of the image which would otherwise not fall on the projection surface may be turned off, to enhance the visual effect. This is particularly effective for projection surfaces which have an irregular shape.

Software of the invention includes a user interface, in which control software references a visible display surface to visible output. A perspective image of a visible display surface, for example a large screen on a stage, is captured by a video camera. The perspective image is captured substantially from the perspective of the tracking device. Using an adjustment area of the control software, a system user moves and selects one or more control points to indicate corresponding points on the perspective image and a corresponding location of the input of the tracking device. When all control points have been set, the perspective image is warped to map to the perspective of the tracking device, thereby correlating relative positions of the perspective of the tracking device with the area of the visible display surface.

In accordance with an additional embodiment of the invention, the system may integrate into a three dimensional environment, interpreting input from more than one tracking device, to develop an output that responds to motion of the players or participants in three dimensions.

In one aspect of the invention, the display output is built into or incorporated into a table or other furnishing. The tracking device or devices are thus advantageously designed to capture movement proximate the furnishing. The tracking devices may be mounted on an elongate flexible stalk, and either the stalk and or the tracking device may be moved to position the tracking device for correct capture of participant movement.

In yet another embodiment of the invention, participants interact with a stage area located on a side opposite to one or more tracking devices. More particularly, the visible display surface may be transparent to tracking device, whereby movement of participants may be detected through the visible display surface. Alternatively, tracking device may be mounted to a side of the visible display surface, and motions detected may be interpreted within software of the invention to compensate for the angular aspect of input data.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a camera in accordance with the invention with a lens attached;

FIG. 2 depicts the camera of FIG. 1 with no lens, and no filter;

FIG. 3 depicts a camera enclosure containing a camera, in accordance with the invention;

FIG. 4 illustrate a table configuration of the invention;

FIG. 5 is a diagrammatic illustration of a configuration in accordance with the invention;

FIG. 6 depicts a system in accordance with the invention, with a projection onto a floor;

FIG. 7 depicts samples of various effects in accordance with the invention;

FIG. 8 depicts a participant interacting with a projected image of a vehicle, with an effect of the invention illlustrated;

FIG. 9 depicts participants interacting with a table configuration of the invention;

FIG. 10 depicts a device housing with adjustable mirror, in accordance with the invention;

FIG. 11 depicts a device configuration in accordance with the invention, installed within a low table;

FIG. 12 illustrates a device housing having two sensors, in accordance with the invention;

FIG. 13 illustrates a housing with adjustable mirror, operative to enclose all components of a system in accordance with the invention;

FIG. 14 illustrates a computer CPU housing in accordance with the invention;

FIG. 15 illustrates a computing system of the prior art, certain components of which are included within the invention;

FIG. 16 illustrates a screen display of coordinating software in accordance with the invention;

FIG. 17 illustrates a screen display of configuration software of the invention, operative to align displayed output with a projection surface;

FIG. 18 illustrates an additional screen display of the configuration software of FIG. 17;

FIG. 19A illustrates an additional user interface screen display of the configuration software of FIG. 17, illustrating an image of a display surface;

FIG. 19B illustrates the interface of FIG. 19A, wherein the corners defining the display surface have been dragged on-screen to specific corner locations, to calibrate tracking and display devices of the invention;

FIG. 20 illustrates a screen display for adding media content and creating a schedule for displayed content, in accordance with the invention;

FIG. 21A illustrates light projected onto an irregular shaped object, a portion of the background illuminated by the projected light; and

FIG. 21B illustrates the irregular shaped object of FIG. 21A, wherein masking is applied to the projected light, resulting in no background illumination.

### DETAILED DESCRIPTION OF THE INVENTION

An interactive system 10 in accordance with the invention creates immersive multimedia experiences through responsive physical interaction and audience participation. Interactive system 10 enables a transformation of surfaces, including floors, walls, screens, and stages, into a captivating interactive experience. System 10 can be used to create environments, interactive branding campaigns, interactive set design, event marketing, permanent installation, product launches, club environments, special events, and other creative projects.

As explained further, below, the system 10 of the invention enables entertaining and engaging audiences by turning them into active participants. System 10 includes one or more tracking devices 260, operative to detect movement of a participant 500, a computer system 100 including software 400, and at least one visible display output device 216. System 10 engages and interests consumers through responsive interactivity, and enables for creative branding and immersive environments. Using the motion tracking ability of the tracking device 260 and software 400, and display aspects of visible output device 216 of system 10, an installer/operator can enable a visible output 20 containing a message which responds to audience participation, creating an immersive experience related to human body movements of participant 500 and or an audience of participants 500.

The interactive system 10 of the invention provides for motion video or other visually projected output 20 that changes and evolves, in cooperation with the viewer or participant 500, whereby participant 500 may continuously interact with the projected output 20. In one aspect of the invention, projected output 20 includes advertising. As further explained below, system 10 includes output devices 240 including projection and media devices that can be readily customized and configured for each project and environment. Existing media or display content may provided for the projected output 20, advantageously as a background to be modified by movement one or more players, or participants or users 500.

Interactive system 10 includes a software application 400 with a setup and programming user interface 410 that is simple to configure, requiring a low level of computer skill and knowledge. It is used in conjunction with external hardware to which it is connected. Together with the external hardware, an output signal, for example a digital signal, is displayed which is modified by motion of the viewer.

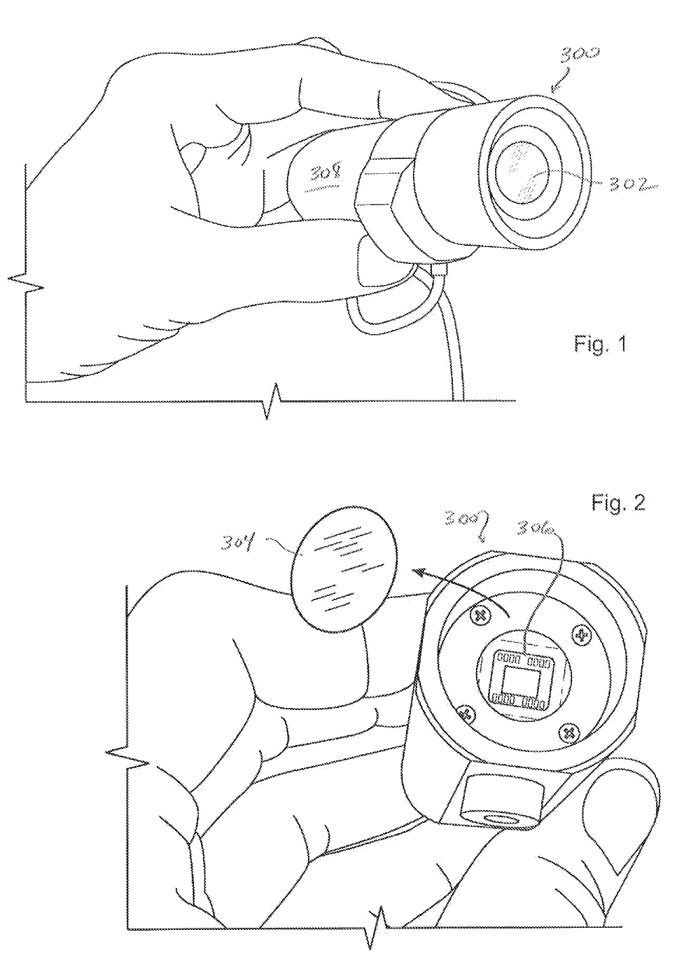

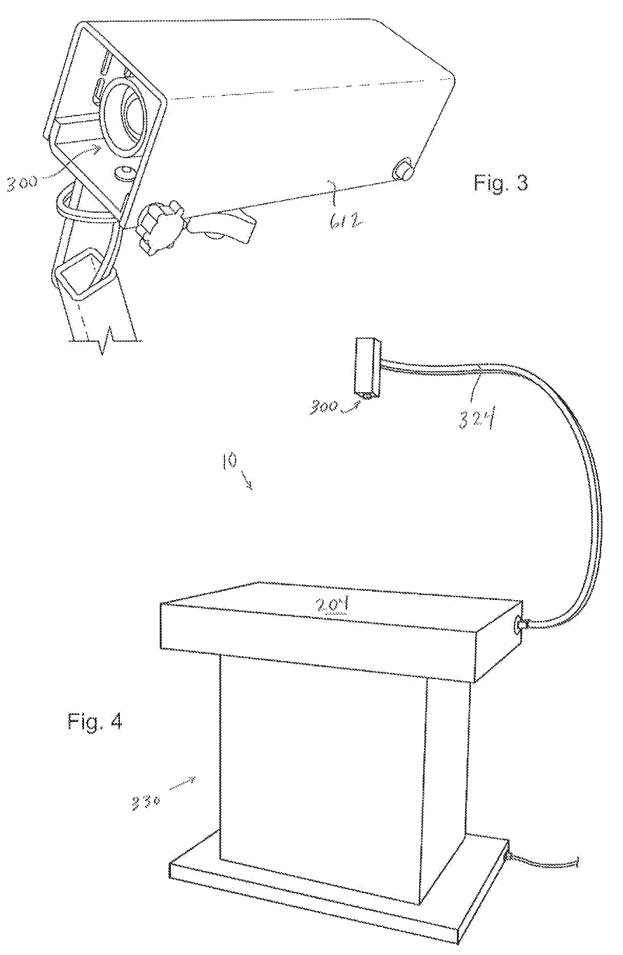

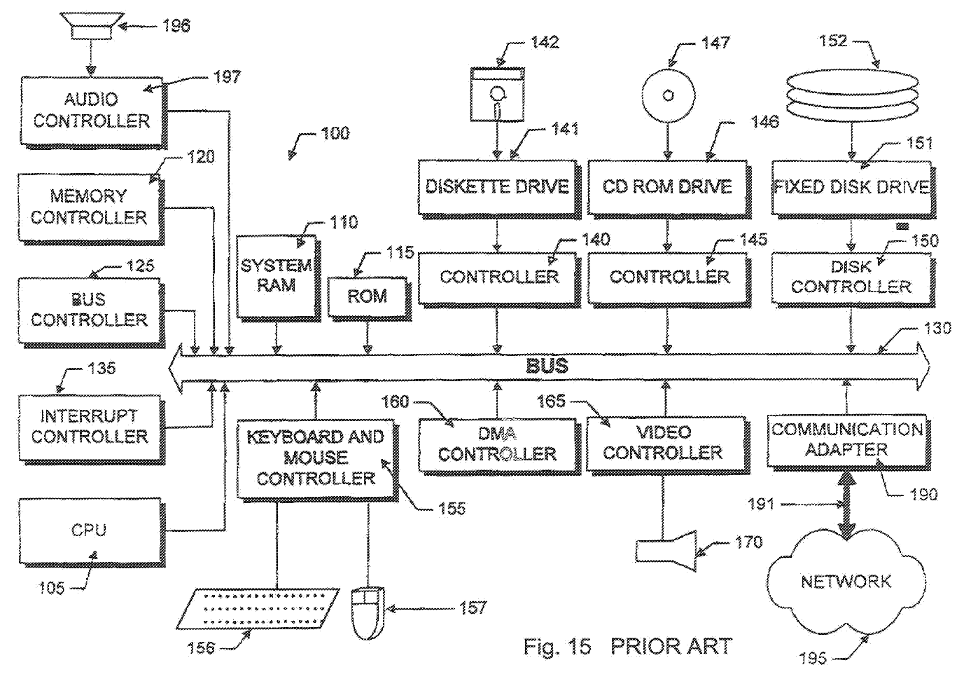

FIG. 15 illustrates the system architecture for a computer system 100 such as a server, work station or other processor on which the invention may be implemented. The exemplary computer system of FIG. 1 is for descriptive purposes only. Although the description may refer to terms commonly used in describing particular computer systems, the description and concepts equally apply to other systems, including systems having architectures dissimilar to FIG. 1.

Computer system 100 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 100. A bus controller 125 is provided for controlling bus 130. An interrupt controller 135 is used for receiving and processing various interrupt signals from the system components.

Mass storage may be provided by diskette 142, CD ROM 147, or hard drive 152. Data and software, including software 400 of the invention, may be exchanged with computer system 100 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 100 also includes a communications adapter 190 which allows the system to be interconnected to a local area network (LAN) or a wide area network (WAN), schematically illustrated by bus 191 and network 195.

Operation of computer system 100 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 105 coordinates the operation of the other elements of computer system 100. The present invention may be implemented with any number of commercially available operating systems.

One or more applications such as a Web browser, for example, Firefox, Internet Explorer, or other commercially available browsers may execute under the control of the operating system.

External hardware includes, in one embodiment, one or more video projectors 200, one or more video cameras 300, and one or more computers 100. The computer 100 receives an input signal 246 from video cameras 300 or other tracking device 260, or multiple tracking devices 260 working together, and modifies the displayed or visible output 20 based upon that input. Computer 100 may also be used to control other devices such as room or effects lighting 206, LED or LCD video screens 204, motors 208, solenoids 210, servos 212, audio devices and synthesizers 214, or any combination of these and other such output devices 216, hereafter referred to as output device 240, controllable by sending an output signal 250, using any or all of wireless protocols 218, serial control 220, Open Sound Control (OSC) 222, Musical Instrument Digital Interface (MIDI) 224, TUIO protocol, or computer networking protocol 226 devices or commands, hereinafter communication protocol 244, each input or output device using the type of communication protocol 244 most suitable for the particular device. A single system computer 100 can be networked to other system computers 100 around the world, using any known means, including for example, the internet In accordance with the invention, a coordinating application 440 of the invention, which may be a Web based application, is used to push or pull new content and playlists (programmed content) to one or more computers 100 using the internet Multiport devices 228 as known in the art may be connected to computer 100 to enable connections to a plurality of similar devices. According to the invention, output to multiple devices of a similar type are coordinated to present a single seamless or substantially seamless output presentation using software 400 of the invention, as described below. It should be understood that system 10 can be used with tracking devices 260 which are not yet known, through interfaces or protocols 244 which exist or may hereafter be developed.

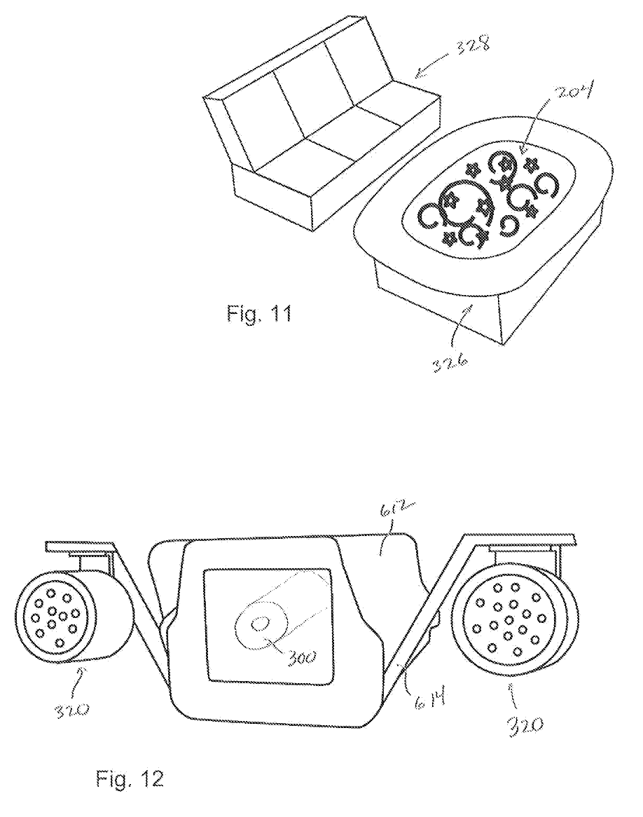

With reference to FIG. 12, a tracking device 260, for example video camera 300, is positioned within a protective housing 612. Wave emitting devices 272, for example IR projectors 320, including infrared lasers or infrared LED clusters, are aimed in cooperation with camera 300, enhancing contrast by reflecting infrared light upon stage area 264 or visible display surface 268. The use of this supplemental light, and particularly light within the IR wavelength, is particularly advantageous in applications where visible light is insufficient for producing good contrast by tracking device 260. Additionally, by configuring or using a tracking device 260 to only, or predominantly detect non-visible wave energy, such as IR, the tracking device is not adversely impacted by visible light reflected from visible output 20. Where it is desired to produce more visible light, of course, light within the visible wavelength may be directed at stage area 264.

Computer 100 is provided with software 400 in accordance with the invention, which includes motion tracking and control software 420, connected to and responsive to movements of the user or participant 500, as observed by motion tracking hardware, described further below, but including, for example, a standard color or black and white or color video camera 300, thermal radiation detection devices 322 responsive to, for example, an IR projection device 320, and other motion sensors as known in the art.

A video camera 300 is advantageously used as a tracking device 260. In one embodiment, an off-the-shelf standard low-resolution black/white CCD 300 may be used. Camera 300 captures a field of view through standard or custom lenses 302. In another embodiment in accordance with the invention, camera 300 is provided with a visible light filter 304 installed between the lens and camera body 308. The visible light filter may be formed, for example, from a piece of negatively exposed slide film cut to fit over the camera CCD element 306. The visible light filter filters out approximately 90% of (human) visible light, enabling camera to see predominantly in the infrared (IR) spectrum; accordingly, if an IR filter is installed in the camera, this filter is advantageously removed. In this manner, the camera may have a view of the resultant displayed image, but does not send this information to the computer, due to the visual content of the displayed image being filtered. As a result, substantially only participant's 500 movement is transmitted from the camera to the computer, improving the signal to noise ratio and the resulting correspondence between the users' movements and the effect displayed.

Camera 300 or other devices of the invention are advantageously mounted in a protective housing, such as is shown in FIGS. 3, 4, 9, 12 and 13, for example. While the housing may be adapted to be mounted at different orientations, to facilitate alignment of the tracking device 260 and visible output 20, it should be understood that rotation may also be accomplished by software 400.

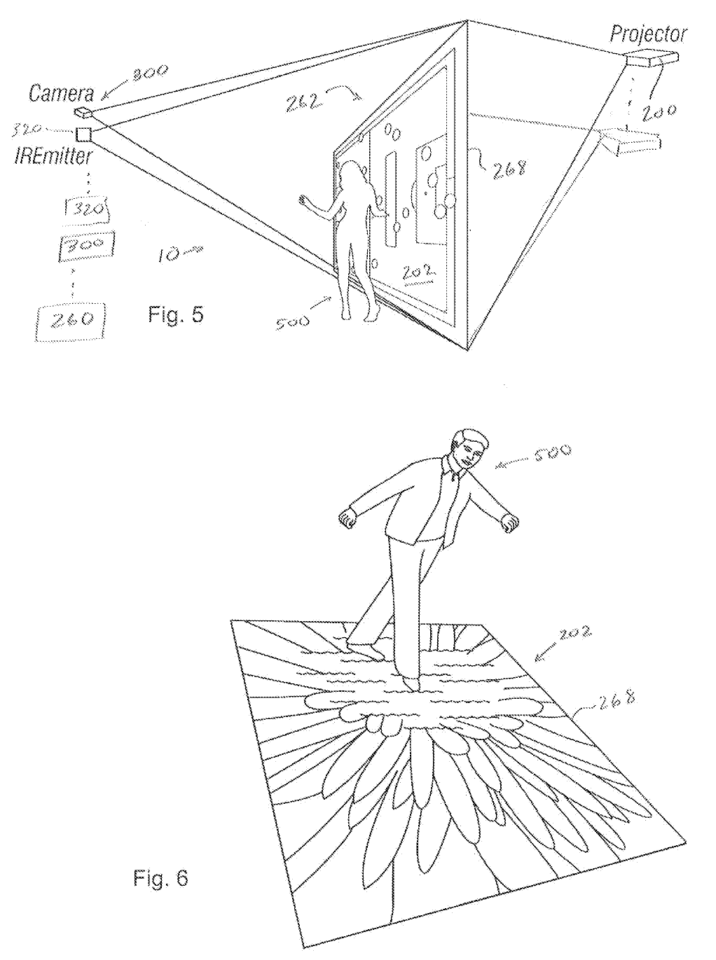

The output signals 250 generated from the various tracking devices 260, such as the video 300 or motion sensors 300, are read or digitized in real-time by the system software 400 of the invention. In accordance with the invention, digitizing methods include point tracking, or the application of a difference function based on input from successive video frames. Data extracted from these messages is used to apply various effects and graphics, or control information of the output signal 250 to the connected output device 240. An LCD monitor 240, video projector 200 or LED video wall 262 is advantageously used as the primary display output 240. As may be seen in FIG. 5, a video wall 262 may comprise multiple video projectors 200 tiled together contiguously, in order to form one large screen. Alternatively, other types of display output devices 202 may be tiled together. As technology develops, each screen tends to become larger, and fewer screens are needed in order to cover a wall or large viewing area. Ultimately, a single display may cover an entire wall or large viewing area, and the use of such a display output is contemplated in accordance with the invention. Alternatively, a video projector may be used to project the resultant output onto any surface of any shape or texture. Moreover, the shape of the projected image may have a mask applied within software 400, whereby portions of the image which would otherwise not fall on the projection surface may be turned off, to enhance the visual effect. This is particularly effective for projection surfaces which have an irregular shape.

More particularly, a video signal from tracking device 260 is analyzed by software 400 on a frame by frame basis, subtracting the foreground object detected by tracking device 260 from the background visible output 20. Software 400 thereby has information pertaining to multiple objects, or objects of complex shape, in the stage area 264. Multiple tracking points corresponding to areas of greatest contrast or movement are then maintained and monitored by software 400 until they become unusable due to less motion, obstructions in the stage area 264, or the move out of stage area 264. New tracking points are continuously created or spawned. Black and white or thermal cameras are advantageously used when the background at which the tracking devices 260 are aimed is also the visible output 20. Thermal cameras may advantageously be set to detect heat in the range of humans, or about 90-105 degrees, for optimal tracking of human movement. If the visible output 20 is not within the field of the view of the tracking device 260, other camera types may be used. For three dimensional movement, at least two cameras are used. A TUIO protocol may be used to capture data from devices of the invention.

Software 400 includes a user interface 410, a portion of which is illustrated in FIG. 17, in which control software 420 references a visible display surface 268 to visible output 20. In FIG. 17, a perspective image 442 of a visible display surface 268, in this example a large screen on a stage, is captured by a video camera 300, or other such device, including, for example, a still camera. Perspective image 442 is captured substantially from the perspective of the tracking device 260. Using an adjustment area 446 of control software 420, a system user moves and selects one or more control points 444 to indicate corresponding points on the perspective image and a corresponding location of the input of the tracking device 260. When all control points have been set, the perspective image is warped, as can be seen in the adjusted output area 448, to map to the perspective of the tracking device 260, thereby correlating relative positions of the perspective of the tracking device with the area of the visible display surface 268.

An alternative method of correlating a tracking device 260 and visible output 20 on a visible display surface 268 is illustrated in FIG. 19. In this method, control software 420 displays the perspective image 442 containing visible display surface 268, together with corner alignment reference points 452. In this embodiment, the image is clicked and dragged to distort the image until the corners of the visible display surface 268 align with reference points 452. Software 400 may then use the coordinates thus obtained to warp the tracking device signal to correspond to the perspective of the tracking device to visible display surface 268, to produce a realistic correlation between tracking and display.

In this manner, a difference in perspective between the tracking device 260 and the video projector 200, or other output device 240, may be compensated for, whereby participants 500 may interact with visible output 20 in a manner which reflects their real world expectations, for example, motioning to move a displayed object causes the object to move when the participant's hand appears to contact the displayed object. In addition, areas within the range or perspective of the tracking device, but outside the perspective of visible display surface 268 may be ignored, or masked off, using software 400.

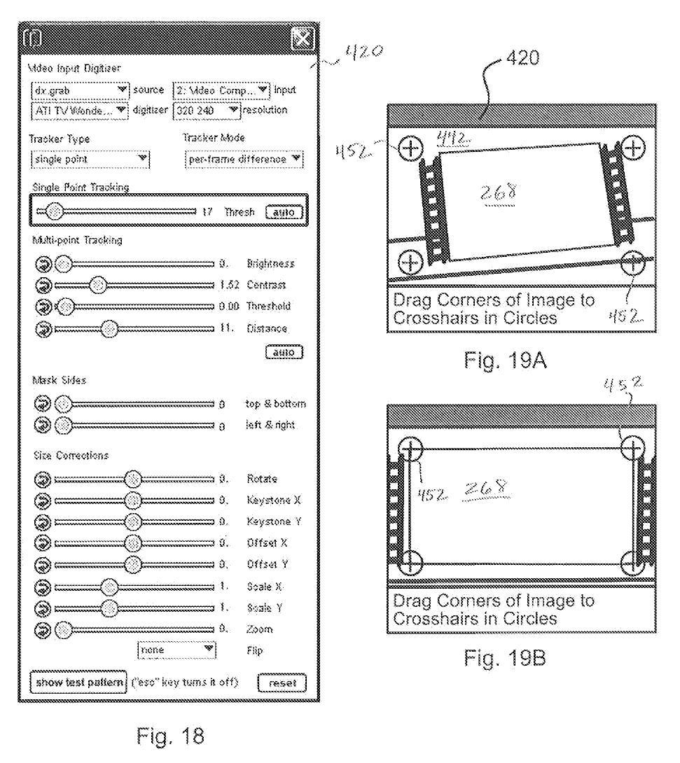

Referring now to FIG. 18, control software 420 enables adjustment in the functioning of tracking device 260, including brightness, contrast, threshold, distance, masking, keystoning, rotation, offsets, scale, zoom, and flip. As can be seen in FIG. 18, drop down boxes as marked enable selection of tracking device 260, input sources, digitizer, and resolution, as well as identifying the type of tracking device 260, and operating mode thereof.

In accordance with an additional embodiment of the invention, and with reference to FIG. 5, system 10 may integrate into a three dimensional environment, interpreting input from more than one tracking device 260, to develop an output that responds to motion of the players or participants in three dimensions.

Visible output 20 can be varied, including graphics and effects, based not only on movement of participant 500, but elapsed time, time of day, user programming instructions inputted into software 400, or other algorithm or image, including for example Flash (a trademark of Adobe Systems, Inc., San Jose, Calif.) movies. Visible output 20 may include still images, or full motion video, captured previously, or contemporaneously. Portions of the displayed content may be altered by system 10 based on participant 500 input or programmed algorithms 400, and other portions may remain static. Further, Web based RSS feeds or other Web based content can be accessed and manipulated based on participant's movements.

Additionally, software 400 of the invention is configured to communicate to external third party applications, including Flash or Unity3d (a mark of Unity Technologies ApS, Frederiksberg, Denmark), using communication structures including TCP/IP, UDP, MIDI, TUIO, and OSC, depending on the external third party application requirements. These applications can be used to greatly increase the types of effects which may be produced by system 10 of the invention.

With reference to FIG. 5, it can be seen that multiple tracking devices 260 and multiple output devices 240 may be used to produce more complex effects, or to produce a larger visible output 20, for example by combining output images. Similarly, multiple computers 100 may be networked locally to divide processing work, produce more complex effects, and or to produce a seamless and larger visible output 20.

In accordance with the invention, participant movement, such as movement of the extremities, can be interpreted by system 10 to produce writing or magic wand effects, the magic wand effective to trigger or generate additional display content, or computer algorithms operative to alter the output display. For example participant 500 movement may be interpreted to press a button visible in the visible output 20.

Specifically, participant 500 moves all or a portion of his body whereby the movement is detected by tracking device 260, which transmits an electronic signal to computer 100, which interprets the signal corresponding to the movement to alter a background image in a way which corresponds to the movement. Tracking device 260 has an input field which may be aimed in a particular direction. Typically, tracking device 260 is aimed directly at the visible output 20, thereby creating a stage area 264 lying between tracking device 260 and visible output 20. Accordingly, movements within stage area 264 may be interpreted to directly correspond to visible output 20. In this manner, movements by participant 500 appear to directly affect objects visible within visible output 20. Specifically, objects in visible output 20 may appear to be moved by participant 500, or objects may appear to be altered in a manner corresponding to movements of participant 500 in a variety of ways, examples of which are detailed below.

The user interface 410 enables participant 500, operator or technician to configure system 10 to display logos, custom images and other video content to serve as background imagery. The operator may further program effects and content based upon a schedule that is user definable. The user interface 410 is a part of the software application 400 of the invention, executed on a system computer 100, which may be, for example, a personal computer. Additional display content or display instructions may be provided to computer 100, or obtained by computer 100, in either a “push” or “pull” updating methodology, over a wireless or wired network, including a local network, wide area network, or the internet. In addition, equipment may communicate using the TUIO protocol. The operator may control the system using one or more operating monitors (not shown), and one or more computers 100.

In a further embodiment, computer 100, tracking or tracking devices 260, display or output devices 240, and any other required material, including documentation or cabling, may be efficiently packed and stored for transportation, in a relatively small and protective configuration.

With reference to FIGS. 4, 9, and 11, in one aspect of the invention, the display output is built into or incorporated into a table 330 or other furnishing. The tracking device or devices 260 are thus advantageously designed to capture movement proximate the furnishing. With reference to FIGS. 4 and 9, the tracking devices 260 are mounted on an elongate flexible stalk 324, which may be moved to position the tracking device 260 for correct capture of participant 500 movement. In the embodiment of FIG. 11, showing a low table 326, or “coffee table”, positioned before a seat 328 or couch, the tracking device 260 is not shown, and is mounted on the ceiling, or other furnishing. In the embodiments shown in FIGS. 4, 9, and 11, the computer 100 may, in addition to the output device 240, be positioned within the furnishing. Multiple output devices 216 may be installed in table 326,330, and the length of the table extended, as desired. For example, a sufficiently long table 326 may advantageously serve as a cocktail bar or meeting table, for entertaining, advertising, or education of numerous patrons or participants 500. Interaction of participants 500 at table 326,330 may cause a change in visible output 20 not only at the table at which they are seated, but also within other visible output 20 in accordance with the invention, located elsewhere within view of the acting participants 500, or to others across a network.

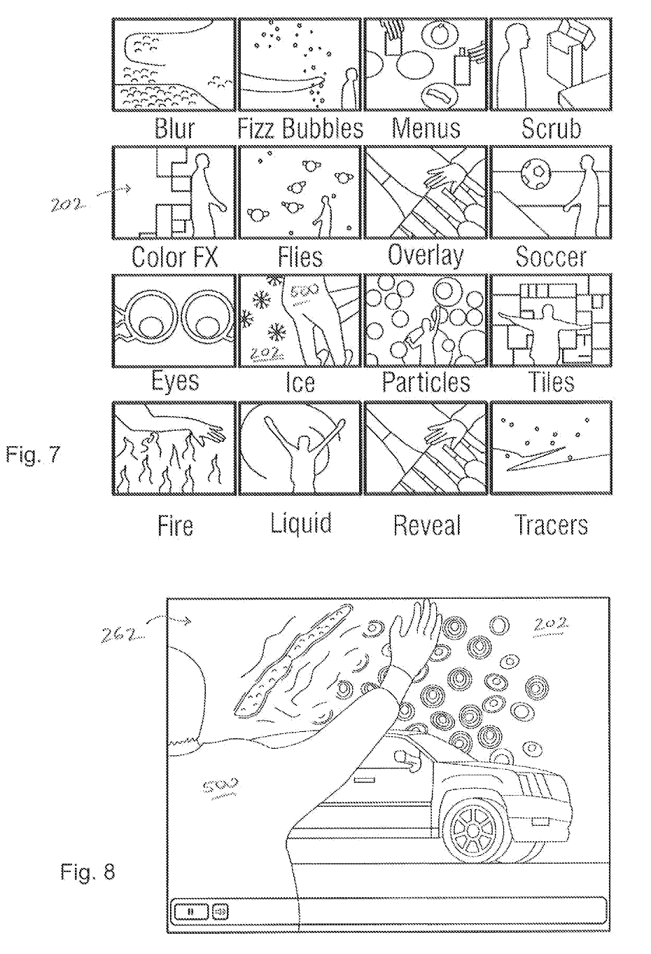

With reference to the figures, and FIG. 7 in particular, system 10 can interpret an input signal 246 based on movement of one or more participants 500, using video effects which are known, or which are described herein in accordance with the invention, which include but are not limited to:

Liquid/Gel Mode: turns still image into liquid or gel (depending on preset used) based on participant's 500 movements.

Reveal Mode: allows participants 500 to use their movements to erase one layer in order to reveal another layer which appears to underlie the revealed layer (this effect can be used for many other “sub” effects, such as the ice/fire and blur/non-blur images, and can use any still image or video file as one or more layers);

Application Mode: using a variety of 3rd party applications, game engine and 3d applications can be incorporated, for example applications which use Flash or OpenGL (a trademark of Silicon Graphics, Inc., Fremont, Calif.), and or which otherwise provide a separate programming interface;

Scrub Mode: participant's 500 movement within stage area 264 causes scrubbing (movement of the playhead) of a movie, for example a Quicktime (a trademark of Apple, Inc.) encoded movie, for an interval, or from start to finish (as examples, depending on the content, it may seem that participant 500 controls the rotation of the earth, or rotating heads follow participant 500, or participant 500 causes an explosion on screen with the wave of a hand);

Digital Feedback: a feedback effect using advanced digital techniques, limited only by what can be produced programmatically;

Overlay: an image, image mask, or logo may be added above another effect, and it will not be distorted by the other effect;

Flash Mode: a Flash programming interface is provided, which is adapted to utilize the input data from participant 500's movement.

An example of specifications for a system in accordance with the invention are as outlined in Table 1, below. All trademarks in Table 1 are the respective marks of their owners.

TABLE 1
Example of System Requirements of the System of the Invention

Hardware:
Intel ® CoreTM 2 Duo Processor E6400 (2 MB L2 Cache,
2.13 GHz, 1066) or greater
Sound card & speakers
2 GB DDR2 SDRAM (533 MHz)
80 GB Hard Drive
256 MB nVidia GeForce 7900 GS Graphic card, 256 MB ATI Radeon
X1900 Pro or better.
http://www.directron.com/tvpcirc.html or any of the ATI TV WONDER
Tuner/Digitizers available, such as
http://www.directron.com/tvwonder200pci.html
Operating System & Extras:
Windows XP (Professional or Home, Service Pack 2)
.NET Framework 1.1 & 2.0 & Service Packs [www.microsoft.com]
DirectX [www.microsoft.com]
Quicktime [apple.com/quicktime/]
Adobe Flash Player [adobe.com]
Adobe Shockwave Player [adobe.com]
Java JRE [www.java.com]
Display:
Control monitor-15″ or greater monitor, almost any will do, supporting
1024 × 768.
Main Display Output Monitor:
Any video projector, with Digital (DVI) or Analog (VGA) connections.
LCD display device, HD monitors, etc. Plasma monitors emit more
infrared light than other monitors, so infrared tracking is not optimal for
these monitors.
Camera:
Camera 300 may be color or black/white, if camera 300 is pointing at
the visible output 20, it must be fitted with a visible light filter 304, in
order to block the visible light from the display. In this manner, camera
300 will only see the movement of participants 500 in front of it.

As an example, an interactive table in accordance with the invention is set up as outlined in Table 2, below.

TABLE 2
Table Set Up Instructions

Raising the table 330 - Lay over method
1. Lay out a blanket or make sure the table is on carpet so that the
metal is not rubbing on hard ground.
2. With the help of another person lift the table out of the case
and set it on the edge of the blanket or carpet
3. find which side of the table is the side with the doors. It will be
the side that has seamed panels in the mid section and the patch panel.
Tip the table on it's side so that the mid section doors are facing up.
4. Expand the table by pulling the bottom away from the top.
Make sure the bottom is resting on carpet or blanket. (Note: the table
expands much easier the straighter you pull both sides
5. Open the doors by removing the screws that hold each side.
You can “pop” the doors open by giving the middle of the
door a good bump and then catch the door as it pops up.
(we need to add a finger hole to the doors to make it easier to open)
6. Insert all 8 bolt/knobs to set the height.
7. With the help of a second person stand the table up.
Attach Arm
1. Put a blanket over the glass to protect it while setting up. It would
be very bad to drop the camera head/arm accidentally onto
the glass!
2. First remove the very end screw from the arm near the camera
head joint.
3. slide the camera head arm in to the joint and line up the screw
hole.
4. reinsert the screw. (make sure to not catch the wire while
feeding the screw through the holes)
5. connect the DIN connector at the table with the Din connector
at the end of the arm.
6. Feed the wire into the table so that all the slack is out
7. Hold 1 hand high up on the camera arm to support the camera
head and use the other hand to insert the arm into the bracket
at the table.
8. Once it is in a little bit you can bump it in further by tapping the
arm with your palm or a rubber mallet. (bump the other side to
detach the arm) Always hold high up on the arm when installing
or removing the arm, it is heavier than it looks!
Turn system on
1. make sure you have an external monitor plugged into the
patch bay before turning the computer on
2. Power it up (there is a switch built in to the D plug at the base)
Adjusting the head
1. Once in tracking mode, you can adjust the angle of the head
for the Y axis by adjusting the Allen screws with springs at the
back of the head.
a. Adjust X movement by loosening the inner knob at the back
of the head and swinging the camera side to side. Tighten the
inner knob when finished.

After software 400 of system 100 begins execution, it logs the IP address, the user-assigned port (a default port is assigned), the date and time, and the user-defined location. This is saved to a local text file, which is then uploaded to an ftp server every hour. Log content may have the following appearance: http://system.<domain>/logs/ip71.111.255.86-text.txt. An XML format is also advantageous.

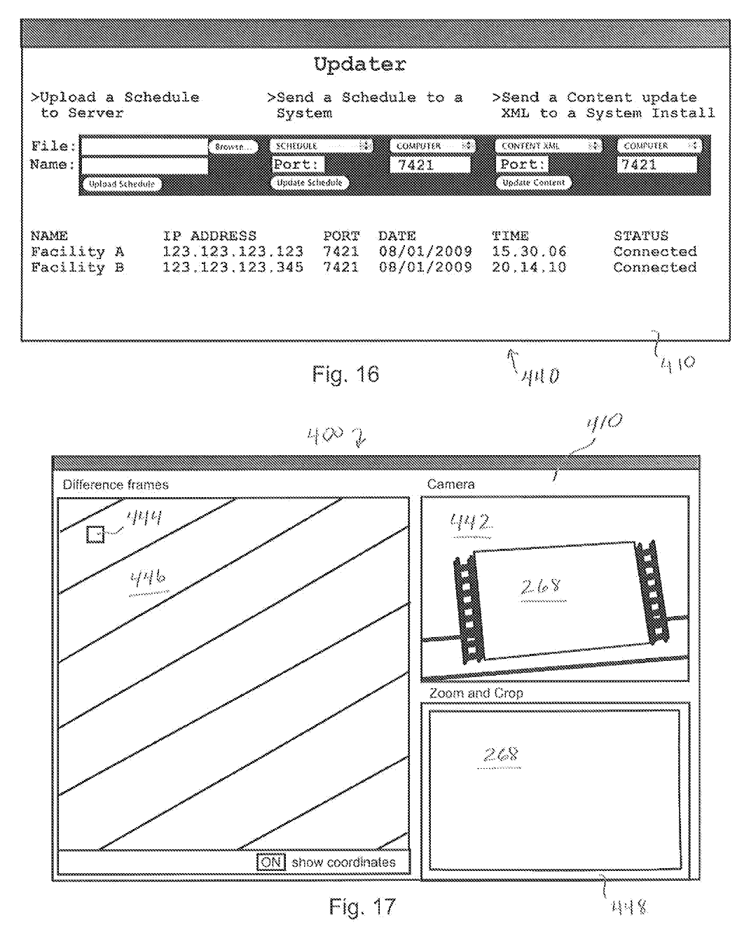

On the server, a Web-based program may have the appearance of the screen display image shown in FIG. 16, which depicts a table listing computers currently installed, parsed from the text files in the “logs/” directory. When a user goes to this page in a browser, a script will run, parsing the data from the text files in the “logs/” directory and creating the table as shown in FIG. 16. Additionally, a menu item may be created corresponding to the current IP, to facilitate entering a record into the updater form. Once records are created, content and schedules can be transferred between systems 10. A Web based form will upload a new schedule, then create a url that will send the new schedule to the specified IP address. This could be done with PHP or other Web based scripting application. The format of this URL may take the form of:

http://update.<domain>/udp/udp.php?ip=<ip>&port=<port>&update=<url to schedule file>, or for example: http://update.<domain>/udp/udp.php?ip=197.125.145.256&port=1234&update=http://www.mlinteractive.net/the systemupdate/DifferentSchedule.txt

The form assembles the URL and view of currently installed machines so the udp.php can operate.

If no port is specified by the user in the form, the value is the default port value.

The schedule text file should maybe be renamed to something other than what is uploaded (e.g. with the IP address appended), so that other directory contents aren't overwritten.

Maintenance is periodically performed on the logs/directory. Files older than a specific time period should be ignored or deleted, as by a chron task.

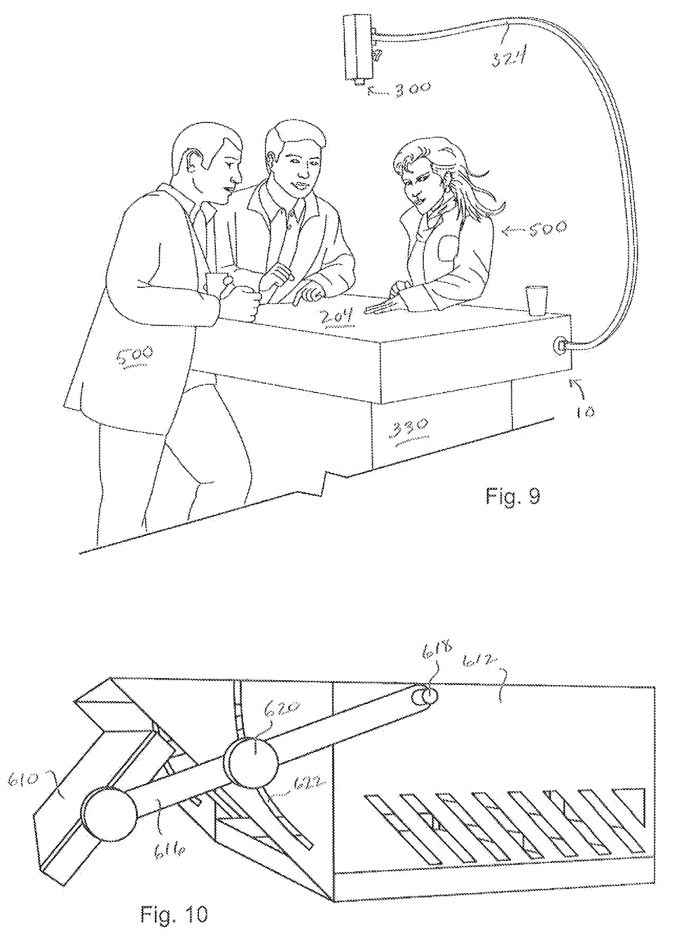

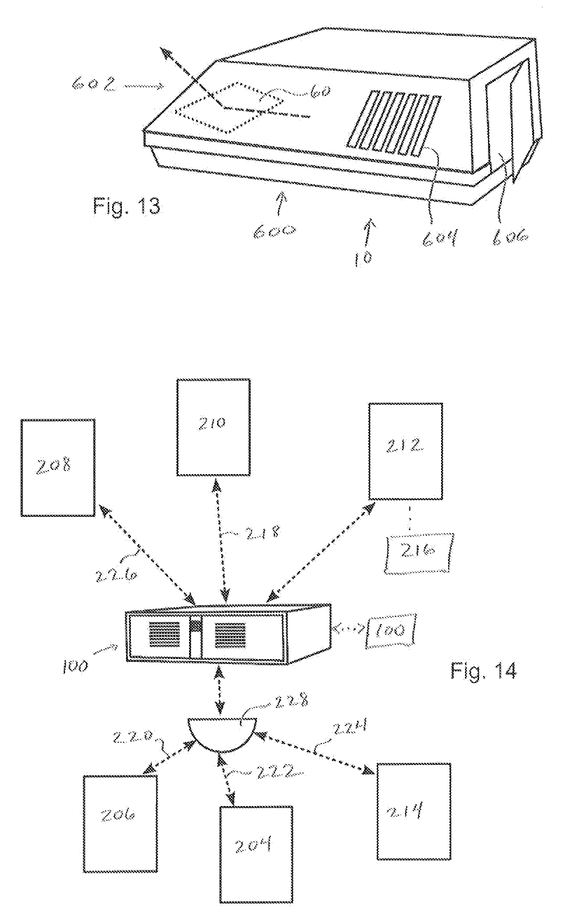

Referring now to FIG. 13, a system 10 in accordance with the invention comprises a housing 600 having a display port 602 through which the visible output 20 may be projected, and an access port 606 enabling manipulation, connection, or adjustment of housed devices. Apertures 604 are provided for cooling, optionally cooperative with a cooling fan, not shown. A video projector 200, computer 100, and tracking device 260 are advantageously contained within housing 600. In this manner, installation and deinstallation are greatly simplified. A focusing and/or aiming mirror 610 is mounted to or within housing 600, facilitating mounting for projection at an angle to a visible display surface 268, for example a wall or floor. With reference to FIG. 10, mirror 610 is rotatably connnected to a distal end of a positioning arm 616, the latter pivotally connected to housing 612 at arm pivot 618. A locking adjuster 620 secures positioning arm 616 at a position within arc 622 in housing 612.

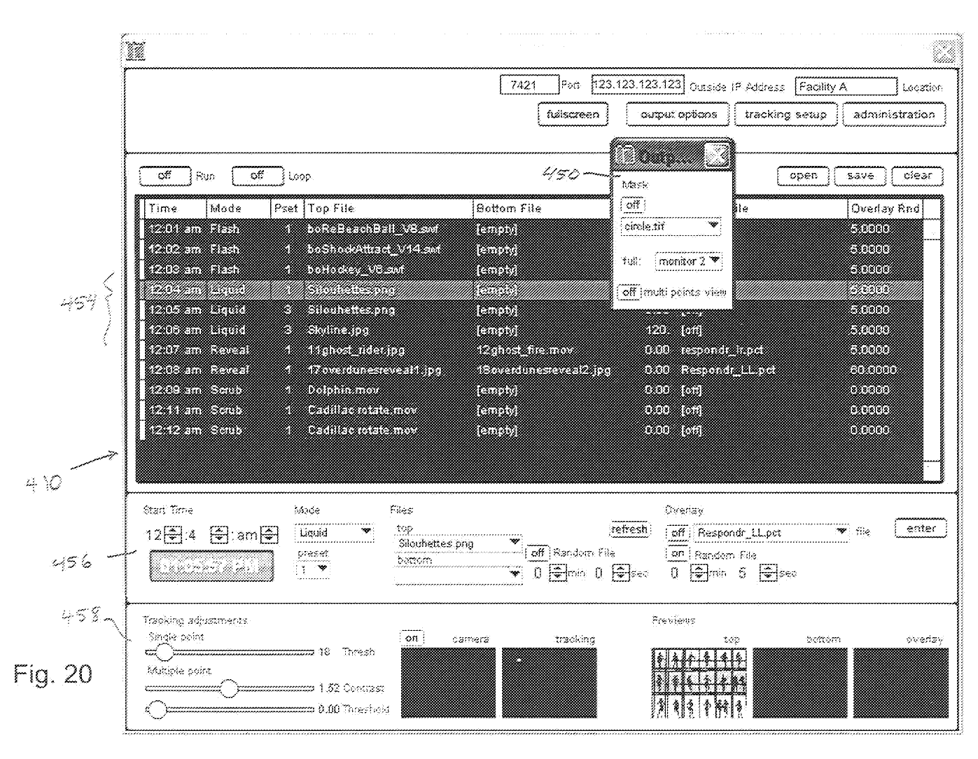

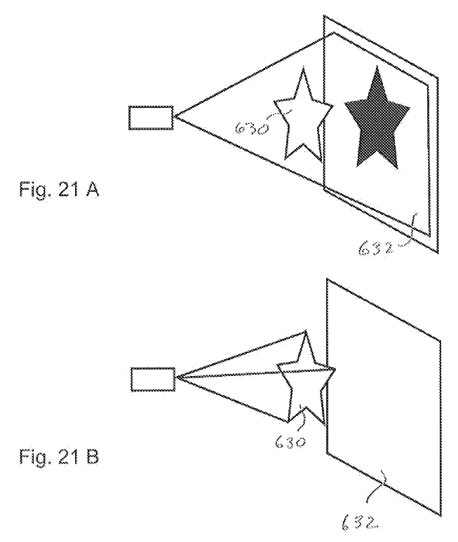

Referring now to FIG. 21A-B, it can be seen that light projected onto irregular shaped object 630 extends beyond the periphery of object 630, illuminating a portion of background 632, and shading a portion based on the shape of object 630. In FIG. 21B, visible output has been masked using software 400, limiting light projected to a shape corresponding to the outlined form of object 630. In this manner, light does not strike background 632. Masking is accomplished by, for example, entering programming instructions into software 400, or alternatively, capturing an image of the object 630, and determining a mask profile based on the captured image, including the techniques described, for example, with respect to FIG. 17, above. This can be advantageous, for example, where it is desired to enhance a visual effect, or to maintain the comfort of viewers positioned behind object 630. An example of a mask interface 450 is shown in FIG. 20, in which shapes may be selected from a drop-down box within a pop-up window.

In accordance with another aspect of the invention, objects may be positioned within stage area 264, to affect visible output 20 as described herein. For example, beverage containers and other personal items may be placed on, in or above table 330, or other visible display surface 268, to effect a change in visible output 20.

In yet another embodiment of the invention, participants 500 interact with a stage area 264 located on a side opposite to one or more tracking devices 260. More particularly, the visible display surface 268 may be transparent to tracking device 260, whereby movement of participants may be detected through the visible display surface 268. Alternatively, tracking device 260 may be mounted to a side of the visible display surface, and motions detected may be interpreted within software 400 to compensate for the angular aspect of input data.

It should be understood that the system 10 of the invention utilizes tracking devices which inherently collect data from many points within the stage area, and where multiple tracking devices 260 are used, multiple points in three dimensions may be obtained. As such, devices of the invention are well adapted to provide any or all of the functionality associated with multitouch software in existence, or to be developed. More particularly, complex finger, hand, limb, or body movements may be interpreted to move separate objects, or move objects in complex ways which are, at the time of this writing, not widely available on personal computers, but are soon to become commonplace. The existing hardware environment of the invention, described herein, is already sufficient to support multitouch interpretations, and existing software 400 supports numerous complex gestures at this time, for example, manipulating a plurality of objects simultaneously. Accordingly, system 10 of the invention may be used to modify a background image on either a multitouch device, or on any of the visible display surfaces described herein, based on finger inputs or other gestures made on the multitouch device or tablet (or other touchscreen type device).

Further in view of the above, tracking device 260 may include frustrated total internal reflection (FTIR) devices (not shown), whereby the visible display surface 268 incorporates a wave emitting device 272, and a tracking device 260. A wave emitting device 272, for example an LED, emits light which is reflected within a planar surface of the device, for example an acrylic sheet, the path of reflected light being changed by objects in contact with a surface of the device. The reflected light then passes through a diffuser to a tracking device 260, whereby a position may be detected of the contacting objects, typically fingers.

Using an FTIR technique or approach, a system 10 of the invention includes tracking devices 260 below a visible display surface 268, which is transparent to the type of tracking device 260 used. IR or other non-visible light may be projected, with the tracking device 260 additionally selected to detect the non-visible light, for example a CCD camera 300. Visible output 20 may then be projected upon the visible display surface 268, modified by movements on the opposite side of visible display surface 268, as tracked by tracking device 260 in accordance with the invention. This system tracking device 260 and projection device 200 to be hidden from participant 500. Accordingly, the invention is readily adapted to supporting TUIO, OSC, and related communication protocols.

In the foregoing and other embodiments described herein, motion sensors, proximity sensors, broken beam/field sensors and other visible and non-visible light sensors serve as tracking device 260, and may be aimed into stage area 264. Where at least two tracking devices 260 are used, X, Y, and Z data, or three dimensional data, may be obtained. Sensor data from different types of tracking devices 260 may be combined to produce effects, including producing 2D or 3D input data.

Referring now to FIG. 20, a main screen of user interface 410 is illustrated, in which a system user may identify the location of system 10 to be configured using a WAN or local IP address, as well as the communication port. Tracking setup may be accomplished as described above, with respect to FIG. 18, and FIGS. 17 and 19A-B. Masking may be accomplished using interface 450. Schedule listing 454 identifies the effects mode, starting time, duration, any associated files, any desired overlay file (behind pop-up 450), and other factors which affect the time sequence of images and effects to be projected and manipulated. A schedule settings area 456 comprises drop-down dialog boxes, buttons, spin dialogs, and other software means for creating schedule listing items to be placed within schedule listing 454. Certain tracking adjustments, as well as previews, are provided in an adjustment area 458. In addition to scheduled actions, the system can be operated in a manual mode, wherein events are scheduled and started immediately.

Additionally in accordance with the invention, computer 100 may be configured to display, during setup, the software 400 user interface 410 on the same visible display surface as is used for the effects, to reduce required equipment and reduce the cost of system 10.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A system for modifying a background image on a display screen based upon movement of a human user, the human user positioned at least partly within a stage area, comprising:
at least one computer system having memory storage and a processor;
at least one display surface;
at least one display output device connectable to said at least one computer system and operable to output a visible image to appear on said at least one display surface, said visible image created using the processor of said at least one computer system, said visible image outputted from said memory storage to said at least one display output device by said at least one computer system;
at least one tracking device, connectable to said computer, operable to detect a change in a position of a plurality of points defined by a shape of the part of the human within the stage area over time without a requirement for contact between the human user and the tracking device, the tracking device further operable to electronically transmit information pertaining to the change in a position to the computer;
at least one background image storable within said memory storage;
a software application at least partially stored within said memory storage, executable by said computer system, and operable to change said at least one background image based upon said information transmitted from said at least one tracking device and one or more visual effects, whereby said change to said at least one background image corresponds to a movement of the part of the human within the stage area, said software application further includes a scheduling interface enabling the selection of a plurality of background images, visual effects, tracking devices, and output display devices, selectable at designated time intervals.

2. The system of claim 1, wherein said display output device is selected from the group consisting of: LCD display, LED display, CRT display, projected display, semi-transparent display, rear projection display, multitouch display, FTIR display.

3. The system of claim 1, wherein said tracking device is selected from the group consisting of: video camera, video camera with visible light filter, video camera and IR light source, broken beam detector, motion sensor, IR detector, proximity detector, photography camera, multitouch device, FTIR device.

4. The system of claim 1, wherein at least two tracking devices are used, and whereby said plurality of points detected correspond to positions of said plurality of points in three dimensions.

5. The system of claim 1, wherein said visual effects are selected from the group consisting of: liquid/gel, reveal, application, scrub, digital feedback, overlay, Flash, Unity3d, blur, fizz bubbles, menus, flies, bouncing ball, eyes, ice, particles, tiles, fire, tracers.

6. The system of claim 1, wherein a plurality of display surfaces are positionable adjacent to one another to form an enlarged display surface, and wherein said at least one display output device is operable to output a visible image on each of said plurality of display surfaces to produce a single coordinated image on said enlarged display surface.

7. The system of claim 1, said at least one computer comprises a plurality of computers, and wherein said plurality of computers are operable to be connected one to another in a network.

8. The system of claim 1, further comprising at least one interface device operably connectable to said at least one computer and said at least one tracking device, whereby a plurality of tracking devices are connectable to a single computer system.

9. The system of claim 1, wherein all elements of the system are connected to a single housing.

10. The system of claim 9, wherein said housing is selected from the group consisting of: coffee table, low table, chair level table, tall standing table, lounge bar, kiosk, wall mounted unit, ceiling mounted unit, floor mounted unit.

11. The system of claim 9, further comprising a stalk, connected to said housing unit and having a proximal end and a distal end, wherein said at least one tracking device is movably connectable to said distal end.

12. The system of claim 1, wherein at least one of said at least one tracking device is contained within a housing, and said housing includes a mirror, said mirror movably positionable in connection with said housing, said mirror operable to reflect an image of the stage area to said at least one tracking device.

13. The system of claim 1, further including at least one transmission device operable to transmit wave energy, said wave energy detectable by said at least one tracking device, said wave energy operable to pass from said at least one transmission device to said stage area, a portion of said transmitted wave energy reflectable from said stage area to said at least one tracking device, said reflected portion changed by the part of the human within said stage area.

14. The system of claim 13, wherein said wave energy is infrared light.

15. The system of claim 13, wherein said at least one transmission device and said at least one tracking device are movably connectable to each other, whereby at least one of said at least one tracking device or at least one of said at least one transmission device may be positioned whereby transmitted energy may be directed to the stage area and reflected from said stage area to said at least one tracking device.

16. The system of claim 1, wherein at least one of said at least one computer system is connected to a network, and wherein said software application is responsive to instructions transmitted over said network.

17. The system of claim 16, wherein said scheduling interface may be controlled at a point on the network remote from said at least one computer.

18. The system of claim 1, further comprising a configuration interface enabling the adjustment of at least one tracking device to match a perspective of at least one display output device.

19. The system of claim 18, wherein said configuration interface enables the warping of a displayed image of at least one display surface.

20. A method of modifying a background image on a display screen based upon movement of a human user, the human user positioned at least partly within a stage area, comprising:
providing at least one computer system having memory storage and a processor;
positioning at least one display surface where it may be viewed;
connecting at least one display output device to the at least one computer system, the display output device operable to output a visible image to appear on the at least one display surface, the visible image created using the processor of the at least one computer system, the visible image outputted from the memory storage to the at least one display output device by the at least one computer system;
connecting at least one tracking device to the computer, the at least one tracking device operable to detect a change in a position of a plurality of points defined by a shape of the part of the human within the stage area over time without a requirement for contact between the human user and the tracking device, the tracking device further operable to electronically transmit information pertaining to the change in a position to the computer;
loading at least one background image into the memory storage;
executing a software application by the computer system, the software application at least partially stored within the memory storage, the software application operable to change the at least one background image based upon the information transmitted from the at least one tracking device and one or more visual effects, whereby the change to the background image corresponds to a movement of the part of the human within the stage area, the software application further operative to schedule the selection of a plurality of background images, visual effects, tracking devices, and output display devices, selectable at designated time intervals.
